(19) United States
(12) Patent Application Publication
(10) Pub. No.: US 2003/0035942 A1
(43) Pub. Date: Feb. 20, 2003

(54) Dual-density cling foam spacer

(76) Inventors: Gary A. Ort Mertl, Calhoun, GA (US); Donnie D. Hensler, Kennesaw, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/010,054

(22) Filed: Dec. 7, 2001

Related U.S. Application Data
(60) Provisional application No. 60/254,212, filed on Dec. 8, 2000.

(51) Int. Cl. B32B 3/00; B32B 3/26; B32B 7/12

(52) U.S. Cl. 428/316.6; 428/317.1

(57) ABSTRACT

A dual-density or dual property foam sandwich with plastic foam on one side having strong tendencies to “cling” to glass or other smooth surfaces and with plastic foam on the other side having a substantially-reduced tendency to cling or bond to glass. Spacers manufactured in accordance with this invention may be produced in a single, integrated process that does not require any adhesive, other chemical bonding agents or intermediates, mechanical adhesions, or laminations.

This application claims the benefit of U.S. Provisional Application No. 60/254,212 entitled “Dual-Density Cling Foam,” filed Dec. 8, 2000, which document is incorporated herein by reference.

### FIELD OF THE INVENTION

This invention relates to a dual-density foam for use in separating adjacent pieces of fragile material, such as glass, and methods of manufacturing such foam.

### BACKGROUND OF THE INVENTION

Because of the delicacy and fragility of glass, glass panes must be stored and transported with the utmost care. To ensure that adjacent glass panes do not jar against each other and thereby shatter or scratch, “spacers” or “shims” are positioned between adjacent glass panes to separate the panes and prevent such inadvertent impact. It is desirable that the spacers adhere to only one of the adjacent glass panes, but not both, to facilitate ease in handling. To ensure that the spacers adhere to only one of the adjacent glass panes, it is desirable for one side of the spacer to be made from material that “clings” to the glass. The other side of the spacer should be made from a neutral material that has little to no clinging tendencies. This allows a user to predict to which side the spacers will adhere when the user separates the sheets of glass and helps the user in arranging the glass for storage and transport.

Traditional spacers have been made from a combination of cork and polyvinyl chloride (“PVC”) foam. A thin sheet of cork is typically laminated to a flexible, plasticized PVC foam, where the foam is already adhered to a removable liner or carrier. The combined foam/cork system is then die-cut into small squares. The small squares are later removed from the liner and positioned between sheets of glass as spacers. The PVC foam is formulated to “cling” to one piece of glass, whereas the cork side provides a neutral surface that will not stick to the adjacent piece of glass. In addition to providing a neutral surface, the cork provides cushioning and shock absorbance to the glass sheets during handling and transport, and cork is a dry, non-sticky surface that does not stick to glass even under the pressure caused by the weight of stacks of glass sheets.

The cost of cork fluctuates and the cost of the manufacturing process for this product makes it relatively expensive. Current construction involves three steps: the cork is produced in one process, the cling foam is produced in another, and the third step requires lamination of the cork and foam together. Additionally, there is a risk of the foam delaminating from the cork due to adhesive failure. U.S. Pat. No. 5,328,937 to Cascino discloses a foam that may be used as a substitute for cork. However, just like cork, the foam has no clinging properties and therefore must subsequently be laminated in the traditional manner to a cling foam.

### SUMMARY OF THE INVENTION

This invention is a dual-density or dual property foam sandwich with plastic foam on one side having strong tendencies to “cling” to glass or other smooth surfaces and with plastic foam on the other side having a substantially-reduced tendency to cling or bond to glass. Spacers manufactured in accordance with this invention may be produced in a single, integrated process that does not require any adhesive, other chemical bonding agents or intermediates, mechanical adhesions, or laminations.

In one embodiment, the invention includes a first foam layer and an adjacent second, higher-density foam layer. The foam layers are made of a flexible, polyvinylchloride foam plastisol, but each layer has different surface properties. The first foam layer promotes attraction or “cling” to smooth surfaces such as glass, while the second foam layer is formed to have less tendency to cling. This may be accomplished by reducing the surface area of the second foam layer that is capable of contacting the glass by, for example, embossing the side of the second layer that is exposed to the glass. The second foam layer also provides cushioning and shock absorbance to the glass sheets during handling and transport.

In one embodiment for making spacers, a first liquid having the desired properties is applied to a carrier sheet and this liquid gels, or becomes semi-solid. After the first layer is in a semi-solid state, a second liquid having the desired properties is applied on top of the first foam layer and the second liquid gels. The carrier sheet with the two layers then enters an oven. Foaming of the layers occurs in the oven, and the two foam layers intermingle and fuse at the interface to form a single structure. Because there is a physical bond, no post-production lamination or adhesive is required and there is no risk of delamination as with cork or cork substitutes. Upon exit from the oven, the second foam layer may be embossed to give its outer surface a rough texture in order to reduce the tendency of the second foam layer to cling to smooth surfaces. The foam sheets produced by this process may be die-cut into desired sizes and the carrier sheet layer removed just prior to using the pieces of foam, or spacers, for separating glass sheets or similar applications.

### BRIEF DESCRIPTION OF THE DRAWINGS

FIG. 1 is a perspective view of one embodiment of a spacer of this invention.

FIG. 2 is a production schematic of one embodiment for making a spacer of this invention.

### DETAILED DESCRIPTION OF THE INVENTION

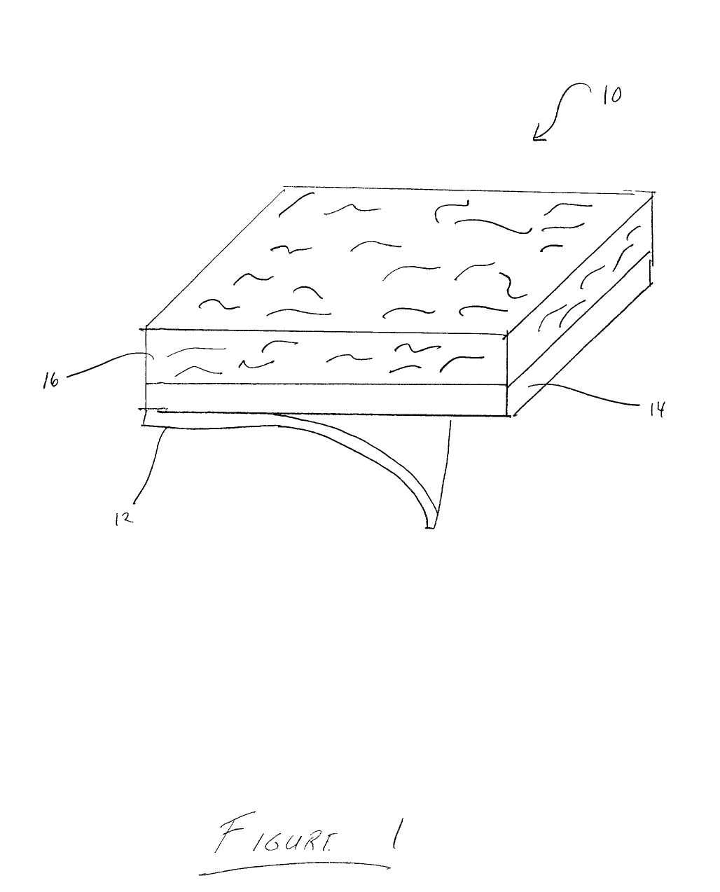

FIG. 1 illustrates an embodiment of a spacer of this invention. As shown in FIG. 1, spacer 10 includes three layers: a release layer 12, a first foam layer 14, and a second foam layer 16. Spacer 10 may include additional layers depending on the specific applications for which it is used.

Release layer 12 may be made from any material that withstands the temperatures contemplated herein and allows a user to peel or remove release layer 12 from the adjacent foam layer, first foam layer 14 in the exemplary embodiment. Release layer 12 is preferably a high-gloss, silicone-treated, gloss-surfaced carrier sheet. Release paper particularly suitable for this application is the S. D. Warren Ultracast™ Paper, ID #132, available from Sappi Fine Paper North America, formerly known as S. D. Warren Paper Company, of Boston, Massachusetts. Before spacer 10 is used, release layer 12 protects first foam layer 14 to prevent inadvertent adhesion of spacer 10 to glass or other smooth surfaces.

First foam layer 14 is located adjacent to release layer 12, and second foam layer 16 is adjacent to first foam layer 14, as shown in FIG. 1. First and second foam layers 14 and 16 may be made of, for example, a flexible, PVC foam plastisol. First foam layer 14 and second foam layer 16 have different surface properties and, preferably, are of different densities. Preferably, the density of first foam layer 14 is lower than the density of second foam layer 16. For example, first foam layer 14 may have a density between about 8-15 lb/ft³, more preferably between about 10-12 lb/ft³. Second foam layer 16 preferably has a relatively higher density of approximately 25-35 lb/ft³.

In alternate embodiments, the first, cling layer may be a highly plasticized PVC solid; an ethylene vinyl acetate; an acrylic, polyethylene, or polyurethane foam or solid; or any polymer that can be formed with either tackiness or a static cling property that allows the polymer to cling to glass (or other smooth surfaces) and be easily removed. Materials that cling to glass using a mild releasable adhesive that does not stain or mar the glass may also be used. Additionally, materials other than high-density foam may be used for forming the to second, non-cling layer. An embossed solid vinyl may be used, but there would be a slight increase in cost, as solid products tend to weigh more per unit area than high-density foams; hence, a high-density foam that exhibits solid-like properties is more economical. Additionally, solids or foams that have resiliency for cushioning effect can be produced from PVC, polyurethane, polystyrene, polyolefin, latex and silicone and are appropriate for forming the second, non-cling layer.

In addition to density, other differences in the physical properties of first foam layer 14 and second foam layer 16 are desirable. First foam layer 14 should be made from materials that promote attraction or “cling” to smooth surfaces such as glass, while second foam layer 16 should be made from materials formulated to have less tendency to cling. Additionally, the surface area of second foam layer 16 that is capable of contacting a smooth surface may also be diminished to further reduce the attraction between second foam layer 16 and the smooth surface. This may be accomplished, for example, by embossing the exposed side of second foam layer 16. Accordingly, when used between glass panes, spacer 10 will adhere to only one of the adjacent glass panes.

Use of a single-layer foam spacer with a single side embossed would not be as useful as the embodiments described above. A spacer made from a single low-density foam layer would be more compressible and unable to withstand the weight of numerous sheets of glass, while a spacer made solely of a high-density foam layer would not possess the necessary characteristics allowing the foam to cling to glass or other smooth surfaces.

To facilitate placement of spacer 10 between glass panes in the proper orientation (i.e., with all of the first foam layers (or cling layers) facing in the same direction), foam layers 14 and 16 may be different colors. This allows users to easily determine at a glance which side of the spacer will cling to glass or other smooth surfaces.

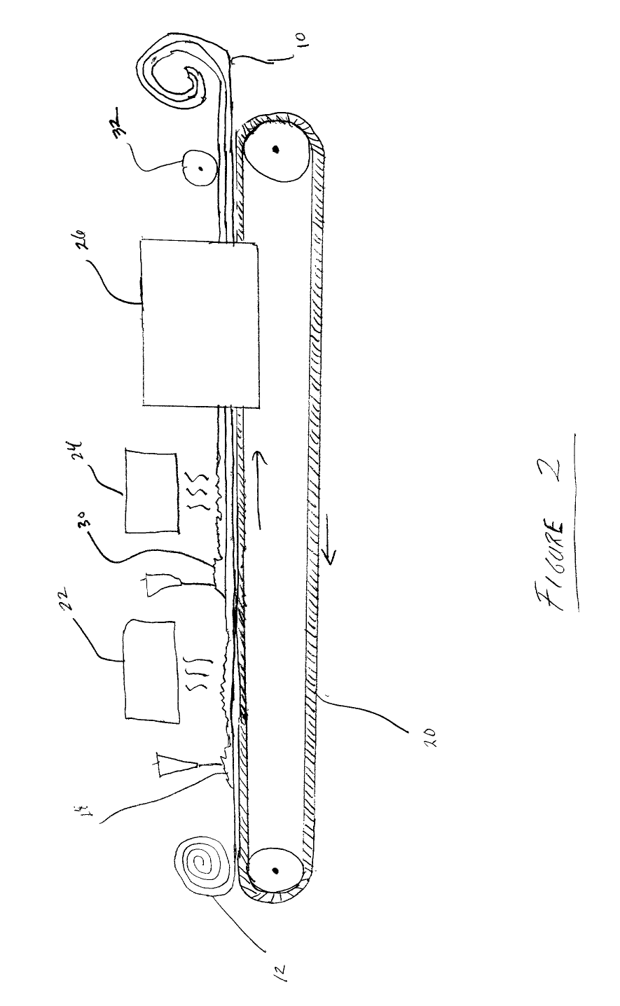

Spacer 10 of the present invention may be, but does not have to be, made using the following method. As shown in FIG. 2, an exemplary processing line includes a belt 20, two infrared heaters 22 and 24, and an oven 26. A first liquid layer of material 28 having the desired properties of first foam layer 14 is applied to a carrier sheet, release layer 12. This first layer of material is permitted to become a semi-solid, or “gelled.” The gelling process may be expedited by mechanical means, such as infrared heaters 22 and 24. After the first layer is in a semi-solid state, a second liquid layer of material 30 having the desired properties of second foam layer 16 is applied on top of the first layer, and second liquid 30 is allowed to gel.

After the first and second layers have gelled, the carrier sheet with the two layers then enters an oven, and the two layers form first and second foam layers that intermingle and fuse at the interface between them as they expand in gauge, forming a single structure. Foaming is caused by the release of gas at the fusion temperature of the material (PVC foam plastisol in the exemplary embodiment described above) used to form the first and second layers, resulting in entrapment of the gas in the material in the form of very fine cells. Chemical blowing agents are used in the formulation of the material to help achieve the desired result. Azodlcarbonamide is a common chemical blowing agent. Others include oxybis(sufonylhydrazide), p-toluene sufonyl semicarbizide, trihydrazine triazine, and other chemicals that decompose when exposed to temperature and release gas. In addition to chemical blowing agents, volatile liquids like methylene chloride and chlorofluorocarbons can be used to create air pockets in the material. Also, foam can be created by mechanical frothing, trapping air in the material by agitation and fusing the product before the air escapes.

Because there is a physical bond between the first and second foam layers, there is no need for added adhesive or other materials to form a chemical bond or any other processing steps. Upon exit from the oven, the top, typically higher density, foam layer (second foam layer 16 in the exemplary embodiment) may be embossed, for instance, with an embossing roller 32 to give the surface a rough texture. This reduces the surface area that will contact glass sheets, further reducing the tendency of this top foam layer to “cling” or bond to such smooth surfaces. The foam sheets are then cooled, wound onto cores, and packaged. The sheets may be die-cut to desired sizes, and users remove release layer 12 just before using the spacers 10 for separating glass sheets or similar applications.

In one embodiment, the processing line speed is about 22 ft/minute at a processing temperature set at approximately 460-510° F., which is the range for three natural gas-fired heating zones. Other processing lines may require different settings, as each plastisol oven is usually unique due to the numerous oven styles, sizes, and configurations.

In another embodiment, the lower density or first liquid layer can go into an oven first, so long as the liquid is at a low enough temperature to adequately gel (about 280° F.) but not fuse (starting at about 350° F.). It is desirable to have both the first and second layers expand at the same time. If the first layer were to fuse and begin expanding before the application of the second liquid layer, gauge and consistency problems would result. The first layer, once it is semi-solid, can have the high-density or second liquid layer poured on top of it without disrupting the consistency of the first layer. In this production method, the oven essentially replaces infrared heaters in providing sufficient gellation temperature.

In yet another embodiment, it is possible to alter the viscosity of the first layer, raising it so high that the first layer becomes “thick.” Then, when a “thinner” viscosity high-density second layer is poured over the first layer, the higher-viscosity first layer liquid will behave more like a semi-solid and not distort. This allows the gellation stage of the first layer to be bypassed.

Vinyl products are oil-based and tend to react poorly with water or moisture, either as a surface contaminant of raw materials or as an unintended liquid in the formulation. Water is a problem because the water will boil and turn to steam as the vinyl starts to gel into a semi-solid, resulting in large water blisters or crates in the vinyl material. For this reason it is desirable to use moisture scavengers to eliminate water in the plastisol, so, for the most part, relative humidity does not play a role in processing.

Generally, the first liquid layer is applied to the carrier sheet via an air-driven pump or piston that moves the liquid from a holding tank to the carrier sheet through a series of pipes and hoses. This is a common means of conveyance in the vinyl plastisol industry. Once on the carrier sheet, the liquid collects behind a doctor blade, which meters the desired gauge of plastisol onto the advancing web of paper. The plastisols may be produced using high-speed Cowles™ blade mixers and de-aerated through the use of a versator.

In the following examples, the formulations are expressed as parts per hundred of resin (“phr”).

### EXAMPLES

| Low-density cling foam layer | phr |
|---|---|
| PVC resin, foam dispersion grade | 100 |
| DUP (Diundecyl Plithalate) Plasticizer | 80 |
| Calcium Carbonate (filler) | 5 |
| Titanium Dioxide dispersion (color) | 10 |
| Azo Dicarbonamide dispersion (blowing agent) | 12 |
| Zinc Octoate dispersion (activator for foam) | 5.67 |
| Silquest A-1100 (processing aid-keeps vinyl on silicone paper) | 0.55 |
| Various pre-dispersed Stabilizers (heat & blowing) | 7.5 |
| Various Moisture Scavengers | 2.5 |

| High-density Foam layer | (phr) |
|---|---|
| PVC resin, foam dispersion & Blending grades | 100 |
| DINP (Diisononyl Phthalate) Plasticizer | 54 |
| BBP (Butyl Benzyl Phthalate) Plasticizer | 10 |
| Calcium Carbonate (filler) | 40 |
| Carbon Black dispersion (color) | 3.25 |
| Azo Dicarbonamide dispersion (blowing agent) | 2.25 |
| Zinc Octoate dispersion (activator for foam) | 1 |
| Various Stabilizers (heat & blowing) | 1.75 |
| Various Moisture Scavengers | 1.5 |
| Viscosity Modifiers, pre-dispersed | 2 |

Substitutes can be used for many of the above components and the stated amounts can be varied. For instance, each item below in column 1 generally can be replaced or varied by the corresponding item in column 2.

TABLE 1

| Column 1 | Column 2 |
|---|---|
| PVC resins | A wide variety of foam dispersion resins and blending |
| | resins |
| Plasticizers | Anywhere from 7-carbons to 12-carbons along the ester |
| | chain |
| Calcium | Varying particle sizes and color grades |
| Carbonate | |
| Colors | Various powdered (pure) or pre-dispersed forms and |
| | concentrations |
| Azo | Various particle sizes and pre-dispersed forms and |
| Dicarbonamide | concentrations |
| Zinc Octoate | Various pre-dispersed forms and concentrations |
| Heat | Various combinations of Calcium, Barium, Zinc, Tin, |
| Stabilizers | Cadmium |
| Viscosity | Various types (fumed silica, lecithin, etc.) and |
| Modifiers | commercial dispersions |

While the invention has been described in terms of various exemplary embodiments, those skilled in the art will appreciate that various modifications, substitutions, omissions, and changes, such as those discussed in the Examples and Table 1 above, may be made without departing from the spirit thereof or the scope of the following claims.

What is claimed is:

1. A spacer suitable for use in separating smooth surfaces of adjacent pieces of fragile material, comprising:
a first foam layer with a tendency to cling to smooth surfaces; and
bonded to the first foam layer to form a single structure without the use of adhesives, laminations, or other bonding agents, a second foam layer having a higher density and a lower tendency to cling to smooth surfaces than the first foam layer.

2. The spacer of claim 1, further comprising a release layer adjacent to the first foam layer, wherein the release layer is removed from the first foam layer prior to use.

3. The spacer of claim 2, wherein the release layer is a silicone-treated, gloss-surfaced carrier sheet.

4. The spacer of claim 1, wherein the first and second foam layers are formed from a flexible, polyvinylchloride foam plastisol.

5. The spacer of claim 1, wherein the first foam layer has a density of about 8-15 lb/ft³.

6. The spacer of claim 1, wherein the second foam layer has a density of about 25-35 lb/ft³.

7. The spacer of claim 1, wherein an exposed surface of the second foam layer is embossed to impart a rough texture.

8. The spacer of claim 1, wherein the first and second foam layers are different colors.

9. A method for forming a multi-density foam structure, comprising:
applying a first liquid to a carrier sheet and allowing the first liquid to gel into a first layer;
applying a second liquid onto the first layer and allowing the second liquid to gel into a second layer; and
curing the first and second layers in the presence of heat to form a single structure with a first foam layer and a second foam layer having a higher density than the first foam layer.

10. The method of claim 9, further comprising applying heat to expedite gelling of the first and second liquids.

11. The method of claim 9, further comprising embossing an exposed surface of the second foam layer to impart a rough texture.

12. The method of claim 9, wherein the first and second foam layers are formed from a flexible, polyvinylchloride foam plastisol.

13. The method of claim 9, wherein the first foam layer has a density of about 8-15 lb/ft³ and the second foam layer has a density of about 25-35 lb/ft³.

14. A method for forming a multi-density foam structure suitable for use in separating smooth surfaces of adjacent pieces of fragile material, comprising:
applying a first liquid to a carrier sheet;
heating the carrier sheet with the first liquid to a first temperature to cause the first liquid to gel to form a first layer;
applying a second liquid onto the first layer to form a second layer; and
heating the carrier sheet, the first layer, and the second layer to a second temperature to cause fusion of the first and second layers to form a single structure with a first foam layer and a second foam layer having a higher density than the first foam layer.

15. The method of claim 14, further comprising embossing an exposed surface of the second foam layer to impart a rough texture.

16. The method of claim 14, wherein the first temperature is at least about 280° F. but less than about 350° F.

17. The method of claim 14, wherein the second temperature is approximately 460-510° F.

18. The method of claim 14, wherein the first and second foam layers are formed from a flexible, polyvinylchloride foam plastisol.

19. The method of claim 14, wherein the first foam layer has a density of about 8-15 lb/ft³ and the second foam layer has a density of about 25-35 lb/ft³.
